(19) United States
(12) Patent Application Publication
(10) Pub. No.: US 2017/0315636 A1
(43) Pub. Date: Nov. 2, 2017

(54) ARTICLE COMPRISING A CAPACITIVE TOUCH DEVICE

(71) Applicant: Novalia Ltd, Cambridge (GB)

(72) Inventor: Kate Stone, Cambridge (GB)

(21) Appl. No.: 15/521,449

(22) PCT Filed: Oct. 22, 2015
(86) PCT No.: PCT/GB2015/053158

§ 371 Date: Apr. 24, 2017

(30) Foreign Application Priority Data
Oct. 24, 2014 (GB) 1418996.3

(51) Int. Cl. G06F 3/044

(52) U.S. Cl. CPC G06F 3/044; G06F 2203/04102; G06F 2203/04103

(57) ABSTRACT

An article, such as globe, comprises a housing portion or substrate, which may be non-flat, and a capacitive touch device, such as an x-y touch pad. The capacitive touch device comprises a first capacitive touch device part which comprises a first substrate supporting a first conductive track or pad and a second capacitive touch device part which comprises a second substrate supporting a second conductive track or pad. The first and second capacitive touch device parts overlap so as to capacitively couple the first conductive track or pad and the second conductive track or pad. The capacitive touch device is disposed adjacent to the housing portion.

### FIELD OF THE INVENTION

The present invention relates to an article which incorporates a capacitive touch device.

### BACKGROUND

Capacitive touch devices can be formed by printing conductive ink on sheets of fibre-based material, such as card, or of plastic. WO 2013/128209 A1 and WO 2013/128208 A1 describe touch-sensitive input devices based on x-y touch.

Capacitive touch devices can be incorporated into articles, such as posters or books, as described, for example, in WO 2014/057251 A1.

Capacitive touch devices tend to be formed on flat surfaces. However, many forms of articles which could benefit from capacitive touch input are curved, sculpted or moulded (herein referred to as “uneven” or “non-flat” surfaces).

Examples of articles having uneven surfaces include globes (which are spherical) and toys. However, incorporating capacitive touch devices (which are flat) into articles which are not flat can be lead to surfaces which are non-responsive to user touch.

US 2009/0314550 A1 describes a capacitance sensitive touchpad that is formed as a plurality of electrodes disposed on a flat substrate. Spaces are created between electrodes which are cut from the substrate whereby the remaining edges of the substrate can then be brought closer together to form a three-dimensional shape, such as a sphere. This approach, however, can suffer one or more drawbacks. For example, conductive regions, due to the shape of the cut out, may be electrically isolated and so become separated from the rest of the touchpad. Moreover, the cut out or crease lines may need to be carefully positioned so as to form the three-dimensional shape. Furthermore, the substrate forms the body of the article and so may be damaged and/or may place limits on the types of surface finish, i.e. may result in an article which is weak and/or which has a poor appearance.

### SUMMARY

According to a first aspect of the present invention there is provided an article comprising a housing portion or substrate, which may be a non-flat housing portion or substrate, and a capacitive touch device. The capacitive touch device comprises a first capacitive touch device part which comprises a first substrate supporting a first conductive track or pad and a second capacitive touch device part which comprises a second substrate supporting a second conductive track or pad. The first and second capacitive touch device parts overlap so as to capacitively couple the first conductive track or pad and the second conductive track or pad. The capacitive touch device is disposed adjacent to the housing portion or substrate.

Thus, a capacitive touch device which is generally flat or is manufactured in a flat form can be incorporated into an article which is not flat simply by cutting and folding, i.e. without the need for complex patterns or interconnections. Moreover, the first and second sheets do not need to be (although they could be) accurately cut and folded.

The capacitive touch device may be an x-y touchpad. The touch elements may include an array of first elements (e.g. rows) spaced apart in a first direction and an array of second elements (e.g. columns) spaced apart in a second, transverse direction.

The capacitive touch device may comprise a substrate. The substrate may comprise a cellulose fibre-based material, such as paper or card. The substrate may comprise plastic. The substrate may comprise a laminate.

Preferably, the housing portion or substrate and the first and second substrates are different. Preferably, the housing portion or substrate and the first and second substrates are formed from different materials. For example, the housing portion or substrate may be relatively durable (or “hard-wearing”) comprising, for example, a suitable material, such as a plastic material used in toys and packaging, such as 3o polyurethane, polyethylene (PE), polypropylene (PP) and polyvinyl chloride (PVC), or a cellulose fibre-based material used in toys, board games and packaging, such as cardboard or hardboard. The plastic may be a thermoset or thermosetting plastic or a thermoplastic. The first and second substrate may be less durable (i.e. prone to tearing or being punctured) and may comprise a material used to make printed matter (such as books or posters) such as paper or card or thin layers of plastic. The housing portion or substrate may be moulded or extruded. The capacitive touch device may be formed by printing (such as flexography, gravure or ink jet) or a print-like process (such as patterning and masked de-metallization of a metallic foil).

The capacitive touch elements may comprise electrically-conductive ink, such as a carbon-based ink. The electrically-conductive ink maybe formed by printing.

The capacitive touch elements may comprise metallic foil.

The non-flat housing portion or substrate may comprise at least part of a sphere.

The first and second substrates may be parts of the same substrate separated by a cut.

The article may further comprise a controller operatively coupled to the capacitive touch device.

The article may be a globe or other model. The article may be a toy, game or product packaging (e.g. secondary or tertiary packaging). The article may be a printed article. The article is preferably three-dimensional.

### BRIEF DESCRIPTION OF THE DRAWINGS

Certain embodiments of the present invention will now be described, by way of example, with reference to the accompanying drawings, in which:

FIG. 1 illustrates a globe;

FIG. 2 illustrates a capacitive touch device comprising capacitive touch elements formed on a flat substrate;

FIG. 3 illustrates a capacitive touch system which is incorporated into the globe shown in FIG. 1;

FIG. 4 shows overlapping capacitive elements;

FIG. 5 illustrates a capacitive coupling formed by the overlapping capacitive elements; and

FIG. 6 illustrates a portion of the globe.

### DETAILED DESCRIPTION OF CERTAIN EMBODIMENTS

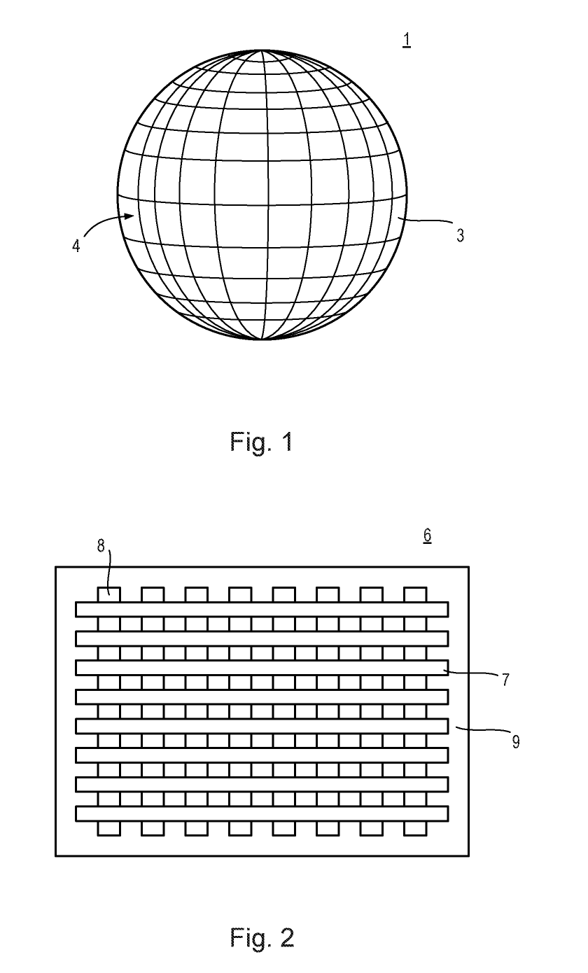

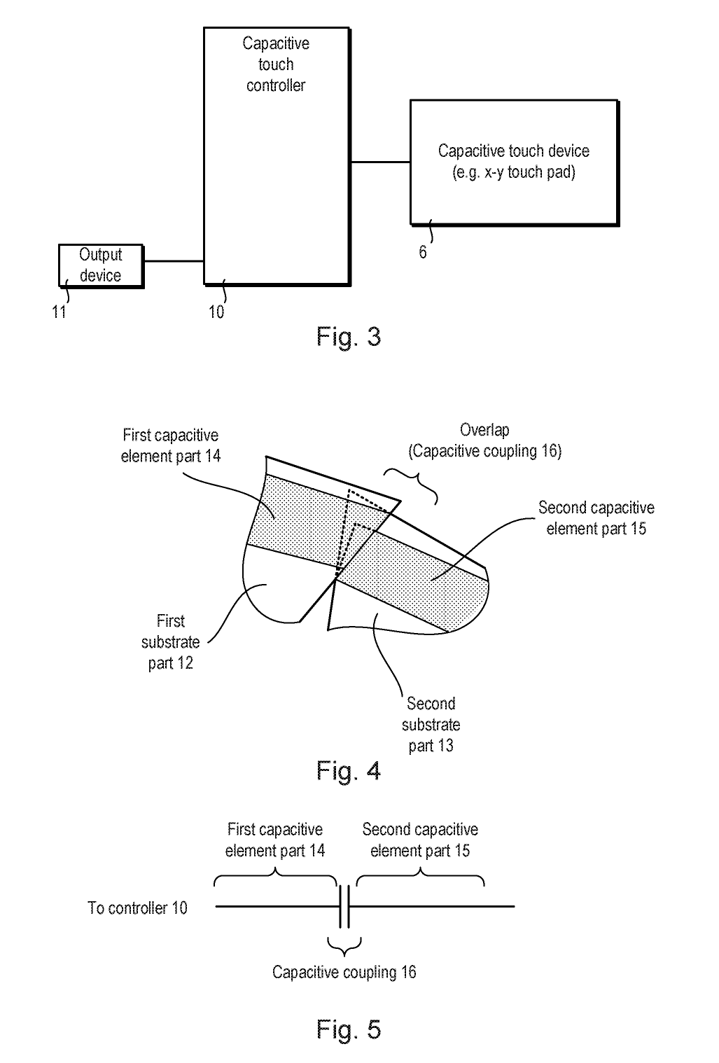

Referring to FIG. 1, an article 1 in the form of a globe, for example of the world, is shown which incorporates a capacitive touch system 2 (FIG. 3). The capacitive touch system 2 (FIG. 3) can be used to make the globe interactive, for example, by stating the name of a country when it is touched by a user.

The article 1 has a housing 3 which is in this case is a non-flat housing portion. The housing 3 may comprise one or more moulded or extruded housing portions comprising a durable plastics material. The housing 3 has an outer surface 4 (which in this case is non-flat) and an inner surface 5 (which in this case is also non-flat).

Referring to FIG. 2, a capacitive touch device 6 in the form of an x-y touch pad is shown. The capacitive touch device 6 comprises capacitive touch elements 7, 8 comprising rows 7 and columns 8 formed on a flat, flexible substrate 9. The substrate 9 may be made from a cellulose fibre-based material, such as paper or card. The capacitive touch elements 7, 8 may comprise conductive ink, such as carbon-based conductive ink.

FIG. 3 illustrates the capacitive touch system 2 which includes a capacitive touch controller 10, such as microcontroller, and the capacitive touch device 6. The row and columns can be formed as a chain or diamond-shaped elements. Suitable touch devices are described in WO 2013/128209 A1 and WO 2013/128208 A1 which are incorporated herein by reference.

The x-y touch pad can be disposed under the map. The capacitive touch system 2 includes one or more output devices 11. An output device 11 may be a sound-emitting device, such as a piezoelectric sounder. An output device 11 may be one or more light-emitting device, such as an LED, or a display. An output device 11 may comprise a wireless network interface, such as Bluetooth® transceiver.

The x-y touch pad can be disposed on the inside of a spherical shell 3 forming the globe.

Referring to FIGS. 4, 5 and 6, in order to accommodate a flat capacitive touch device and spherical globe shell, the substrate 9 of the capacitive touch device 6 may be cut. Slits and/or cut outs can be made in the sheet to allow it to be folded into a generally spherical or part-spherical shape.

The cuts may cut through tracks and/or capacitive touch elements. However, by overlapping strips or different parts of the substrate 12, 13, different capacitive touch elements parts 14, 15 (e.g. forming part of the same row or column) can be capacitively coupled as described in WO 2014/096772 A1 which is incorporated herein by reference. Thus, a first capacitive element part 14 may be electrically isolated by the substrate, air gap and/or other dielectric material, such as a layer of non-conductive glue or ink, or intermediate sheet of material. Nevertheless, the first capacitive element part 14 is capacitively coupled to a second capacitive element part 15 via a capacitive coupling 16. An area, A, of overlap, may be of the order of a few square millimetres to a few tens of square millimetres. Reference is made to WO 2014/096772 A1 ibid.

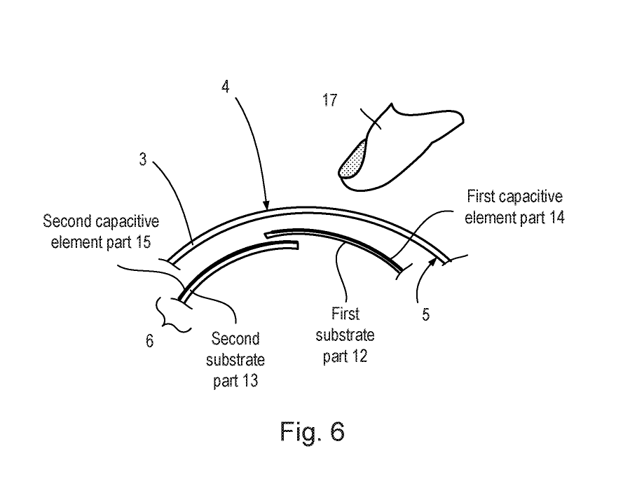

As shown in FIG. 6, a user's finger 17 may be sensed by a first capacitive element part 15 and be coupled to an input pin (not shown) of the capacitive touch controller 10 via the capacitive coupling 16.

The capacitive touch device may be stuck with tape or adhesive to the inside of the globe. Preferably, the capacitive touch device is generally conformal with the inside surface 5.

It will be appreciated that many modifications may be made to the embodiments hereinbefore described.

The article need not be a globe, but may be another form of model or sculpted-like object. The article may be a toy, game or product packaging (e.g. secondary or tertiary packaging). The article may be a printed article. The article is preferably three-dimensional. First and second housing portions, which may be flat, curved or moulded (or “contoured”) may overlie each other and the capacitive touch device may be interposed between first and second housing portions

The housing may comprise flat portions. For example, the housing may comprise a cube or other three-dimensional object having flat faces. The housing may comprise convex and/or concave portions

1. An article comprising:
a housing portion or substrate;
a capacitive touch device, comprising:
a first capacitive touch device part which comprises a first substrate supporting a first conductive track or pad; and
a second capacitive touch device part which comprises a second substrate supporting a second conductive track or pad; wherein the first and second capacitive touch device parts overlap so as to capacitively couple the first conductive track or pad and the second conductive track or pad and
wherein the capacitive touch device is disposed adjacent to the housing portion or substrate.

2. An article according to claim 1, wherein the housing portion or substrate is non-flat housing portion or substrate.

3. An article according to claim 2, wherein the non-flat housing portion or substrate comprises at least part of a sphere.

4. An article according to claim 2, wherein the non-flat housing portion or substrate comprises a molded or extruded part.

5. An article according to claim 1, wherein the housing portion or substrate and the first and second substrates comprise different material.

6. An article according to claim 5, wherein the housing portion or substrate comprises a plastic material.

7. An article according to claim 5, wherein the first and second substrates a plastic material.

8. An article according to claim 5, wherein the first and second substrates a fibre-based material.

9. An article according to claim 1, wherein the first and second substrates are parts of the same substrate separated by a cut.

10. An article according to claim 1, wherein the first and/or second conductive track or pad comprises conductive ink.

11. An article according to claim 1, further comprising:
a controller operatively coupled to the capacitive touch device.

12. An article according to claim 1, which is a model, such as a globe.

13. An article according to claim 1, which is a toy.
